(19) United States
(12) Patent Application Publication
(10) Pub. No.: US 2024/0013054 A1
(43) Pub. Date: Jan. 11, 2024

(54) Confronting Domain Shift in Trained Neural Networks

(71) Applicant: National Technology & Engineering Solutions of Sandia, LLC, Albuquerque, NM (US)

(72) Inventor: Carianne Martinez, Albuquerque, NM (US)

(21) Appl. No.: 18/216,194

(22) Filed: Jun. 29, 2023

Related U.S. Application Data
(60) Provisional application No. 63/358,978, filed on Jul. 7, 2022.

(51) Int. Cl. G06N 3/084; G06N 3/04

(52) U.S. Cl. CPC G06N 3/084; G06N 3/04

(57) ABSTRACT

Neural network prediction correction is provided. The method comprises training a neural network with time series training data from a first domain over a number of training iterations, wherein a random subset of nodes in the neural network is dropped out during each training iteration. The trained neural network generates a number of predictions based on time series data from a second domain, wherein a random subset of nodes in the neural network is dropped out for each prediction to generate a prediction distribution. An uncertainty value is calculated for each prediction. Responsive to determination that the uncertainty value for a prediction exceeds a specified threshold, the prediction is updated to incorporate a corrective factor according to expectations based on domain knowledge.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The disclosure relates generally to artificial neural networks, and more specifically to correcting for shift from the training domain to application.

### 2. Description of the Related Art

Neural networks have seen great success in accurately modeling nonlinear functions by learning directly from observed data. Techniques such as Transformers and Long Short Term Memory (LSTM) models have been applied to natural language processing (NLP), excelling at tasks such as language translation and answering text based questions. These models have been extended to scientific domains where physical laws govern the dynamics of a system. However, while the performance of a neural network may be acceptable when the target domain is closely aligned with the training domain, its performance can degrade when the target domain deviates significantly from the training set. This limitation prevents them from use in high consequence environments such as those monitored by structural health monitoring (SHM) systems, where system failure directly implies that the dominant physics of the system shifts, and indications of this failure must be identified and mitigated to ensure public safety.

Techniques to improve deep learning (DL) model performance on targets that have shifted from the training domain have been proposed in the literature. These methods often augment the training data set to more closely match the target deployment domain. They require expensive retraining of models and are not feasible when rapid approximations of system dynamics are necessary.

Therefore, it would be desirable to have a method and apparatus that take into account at least some of the issues discussed above, as well as other possible issues.

### SUMMARY

An illustrative embodiment provides a computer-implemented method for neural network prediction correction. The method comprises training a neural network with time series training data from a first domain over a number of training iterations, wherein a random subset of nodes in the neural network is dropped out during each training iteration. The trained neural network generates a number of predictions based on time series data from a second domain, wherein a random subset of nodes in the neural network is dropped out for each prediction to generate a prediction distribution. An uncertainty value is calculated for each prediction. Responsive to determination that the uncertainty value for a prediction exceeds a specified threshold, the prediction is updated to incorporate a corrective factor according to expectations based on domain knowledge.

Another illustrative embodiment provides a system for neural network prediction correction. The system comprises a storage device that stores program instructions and one or more processors operably connected to the storage device and configured to execute the program instructions to cause the system to: train a neural network with time series training data from a first domain over a number of training iterations, wherein a random subset of nodes in the neural network is dropped out during each training iteration; generate, by the trained neural network, a number of predictions based on time series data from a second domain, wherein a random subset of nodes in the neural network is dropped out for each prediction to generate a prediction distribution; calculate an uncertainty value for each prediction; and responsive to determination that the uncertainty value for a prediction exceeds a specified threshold, update the prediction to incorporate a corrective factor according to expectations based on domain knowledge.

Another illustrative embodiment provides a computer program product for neural network prediction correction. The computer program product comprises a computer-readable storage medium having program instructions embodied thereon to perform the steps of: training a neural network with time series training data from a first domain over a number of training iterations, wherein a random subset of nodes in the neural network is dropped out during each training iteration; generating, by the trained neural network, a number of predictions based on time series data from a second domain, wherein a random subset of nodes in the neural network is dropped out for each prediction to generate a prediction distribution; calculating an uncertainty value for each prediction; and responsive to determination that the uncertainty value for a prediction exceeds a specified threshold, updating the prediction to incorporate a corrective factor according to expectations based on domain knowledge.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a sequential prediction system in accordance with illustrative embodiments;

FIG. 2 is a diagram that illustrates a node in a neural network in which illustrative embodiments can be implemented;

FIG. 3 is a diagram illustrating a neural network in which illustrative embodiments can be implemented;

FIG. 4 depicts a flowchart illustrating a process of neural network prediction correction in accordance with an illustrative embodiment; and

FIG. 5 is a diagram of a data processing system depicted in accordance with an illustrative embodiment.

### DETAILED DESCRIPTION

The illustrative embodiments recognize and take into account that overfitting of deep learning models to a specific training domain is a known weakness of neural networks.

The illustrative embodiments also recognize and take into account that the problem of domain shift from a training domain to a target domain is an open and active area of deep learning research. Much of this work focuses on computer vision applications such as the problem in the context of convolutional neural networks and proposed a metric for identifying domain shift in images that leverages information about the neural net weights. Other existing works focus on data augmentation, retraining models to better generalize, and training additional models. A CORAL (CORelation ALignment) loss function can be used to effectively transform the features in the network itself to be relevant to a shifted domain. This approach requires unlabeled examples of the shifted domain to learn transformations in the feature space that will reduce the CORAL loss. Generative modelling can also be used to align the shifted domain with the training domain using both pixel-level and feature-level transformations. Domain adaptation techniques can also mitigate shifts in data by training separate models to preprocess the shifted inputs to more closely match the training domain. However, all these approaches require additional resources.

The illustrative embodiments provide a method for correcting for domain shifts in neural networks by leveraging information that already exists in the weights of the trained model, realized in the form of uncertainty estimate, thereby obviating the need for additional data or training. In contrast to prior approaches, the illustrative embodiments actively use uncertainty estimates to correct deep learning model predictions without retraining. The illustrative embodiments implement dropout networks to quantify the uncertainty in deep learning model predictions due to their ease of implementation and their effectiveness with only a single model to be trained.

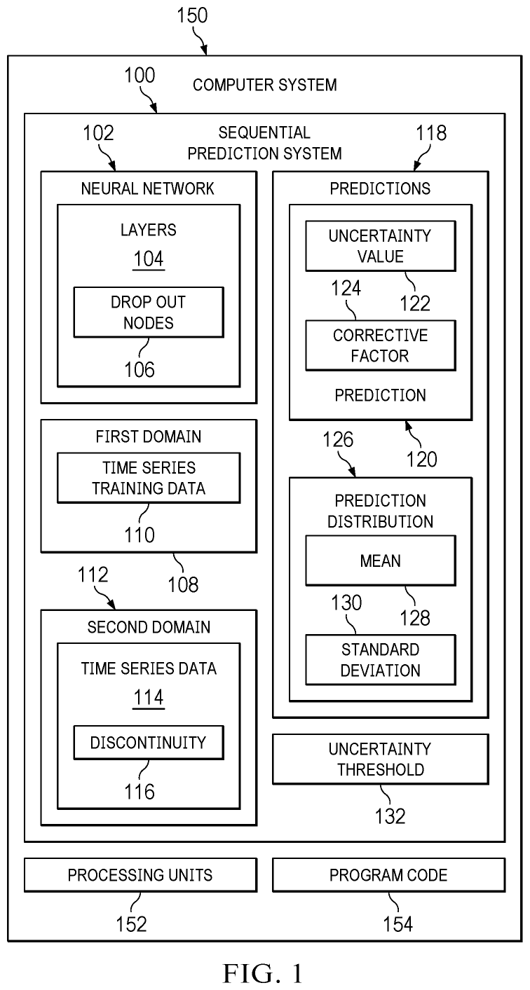

FIG. 1 depicts a block diagram of a sequential prediction system in accordance with illustrative embodiments. Sequential prediction system 100 comprises neural network 102, which is trained over a number of iterations with time series training data 110 from a first domain 108. During training, drop out nodes 106 are selected and dropped from layers 104 in the neural network 102. A different set of drop out nodes 106 is randomly selected for each iteration of training. Node dropout might be applied to all layers 104 of the neural network 102 or only to certain layers (e.g., decoder layers) depending on the architecture in question.

After training, neural network 102 is provided time series data 114 from a second domain 112. From this time series data 114, neural network 102 makes a number of predictions 118. As during the training phase, drop out nodes 106 are randomly selected for each prediction 120. Unlike the time series training data 110 in the first domain 108, the time series data 114 in the second domain 112 includes a discontinuity 116, which represents a sudden change in the sequential data about the physical system being modeled and predicted. For example, in the example of the oscillation of a spring, the discontinuity 116 might represent the spring breaking due to load and/or material fatigue. In this manner, the time series data 114 of the second domain 112 is intended to throw the neural network 102 a “curveball” to determine how it will compensate.

Due to the drop out nodes 106, each prediction 120 of the neural network 102 has an associated uncertainty value 122. In addition, due to the changing selection of drop out nodes 106, predictions 118 have a resulting prediction distribution 126. If the uncertainty value 122 of a given prediction 120 exceeds a predetermined uncertainty threshold 130, a corrective factor 124 is used to update the prediction. This corrective factor 124 might comprise replacing the nominal prediction 120 with the mean 128 of the prediction distribution 126 or adding the standard deviation 130 of the prediction distribution to the nominal prediction in the direction of distribution skew.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 150 is a physical hardware system and includes one or more data processing systems. When more than one data processing system is present in computer system 150, those data processing systems are in communication with each other using a communications medium. The communications medium can be a network. The data processing systems can be selected from at least one of a computer, a server computer, a tablet computer, or some other suitable data processing system.

As depicted, computer system 150 includes a number of processor units 152 that are capable of executing program code 154 implementing processes in the illustrative examples. As used herein, a processor unit in the number of processor units 152 is a hardware device and is comprised of hardware circuits such as those on an integrated circuit that respond and process instructions and program code that operate a computer. When a number of processor units 152 execute program code 154 for a process, the number of processor units 152 is one or more processor units that can be on the same computer or on different computers. In other words, the process can be distributed between processor units on the same or different computers in a computer system. Further, the number of processor units 152 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

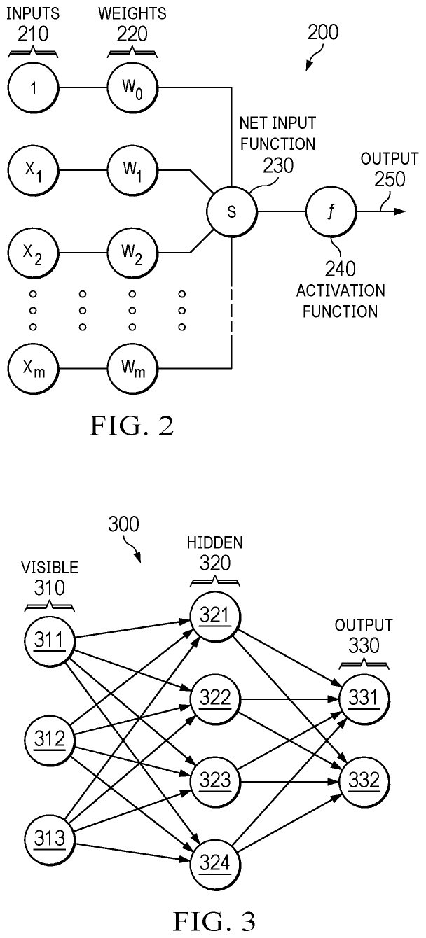

FIG. 2 is a diagram that illustrates a node in a neural network in which illustrative embodiments can be implemented. Node 200 combines multiple inputs 210 from other nodes. Each input 210 is multiplied by a respective weight 220 that either amplifies or dampens that input, thereby assigning significance to each input for the task the algorithm is trying to learn. The weighted inputs are collected by a net input function 230 and then passed through an activation function 240 to determine the output 250. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

FIG. 3 depicts a diagram illustrating a neural network in which illustrative embodiments can be implemented. As shown in FIG. 3, the nodes in the neural network 300 are divided into a layer of visible nodes 310, a layer of hidden nodes 320, and a layer of output nodes 330. The nodes in these layers might comprise nodes such as node 200 in FIG. 2. The visible nodes 310 are those that receive information from the environment (i.e., a set of external training data). Each visible node in layer 310 takes a low-level feature from an item in the dataset and passes it to the hidden nodes in the next layer 320. When a node in the hidden layer 320 receives an input value x from a visible node in layer 310 it multiplies x by the weight assigned to that connection (edge) and adds it to a bias b. The result of these two operations is then fed into an activation function which produces the node's output.

In fully connected feed-forward networks, each node in one layer is connected to every node in the next layer. For example, node 321 in hidden layer 320 receives input from all of the visible nodes 311, 312, and 313 in visible layer 310. Each input value x from the separate nodes 311-313 is multiplied by its respective weight, and all of the products are summed. The summed products are then added to the hidden layer bias, which is a constant value that is added to the weighted sum to shift the result of the activation function and thereby provide flexibility and prevent overfitting the dataset. The result is passed through the activation function to produce output to output nodes 331 and 332 in output layer 330. A similar process is repeated at hidden nodes 322, 323, and 324. In the case of a deeper neural network, the outputs of hidden layer 320 serve as inputs to the next hidden layer.

Training a neural network occurs in a supervised fashion with training data comprised of a set of input-output pairs, (x,y), where x is an input example and y is the desired output of the neural network corresponding to x. Training typically proceeds as follows. Each x in the training data set is input to the neural network at visible layer 310, and the neural network processes the input through the hidden layer 320 to produce an output, y′, at output layer 330. This predicted output, y′, is compared to the desired output y corresponding to input x from the training data set, and the error between y′ and y is calculated. Using a calculus-based method known as backpropagation, the amount of each node's contribution to the prediction error is calculated, and each node's weight is adjusted to improve the neural network's prediction. Several training iterations are typically used to train the neural network to a desired level of accuracy with respect to the training data.

In machine learning, the aforementioned error is calculated via a cost function that estimates how the model is performing. It is a measure of how wrong the model is in terms of its ability to estimate the relationship between input x and output y, which is expressed as a difference or distance between the predicted value and the actual value. The cost function (i.e., loss or error) can be estimated by iteratively running the model to compare estimated predictions against known values of y during supervised learning. The objective of a machine learning model, therefore, is to find parameters, weights, or a structure that minimizes the cost function.

Gradient descent is an optimization algorithm that attempts to find a local or global minima of a function, thereby enabling the model to learn the gradient or direction that the model should take in order to reduce errors. As the model iterates, it gradually converges towards a minimum where further tweaks to the parameters produce little or zero changes in the loss. At this point the model has optimized the weights such that they minimize the cost function.

Neural network layers can be stacked to create deep networks. After training one neural net, the activities of its hidden nodes can be used as inputs for a higher level, thereby allowing stacking of neural network layers. Such stacking makes it possible to efficiently train several layers of hidden nodes. Examples of stacked networks include deep belief networks (DBN), deep Boltzmann machines (DBM), recurrent neural networks (RNN), convolutional neural networks (CNN), multilayer perceptrons, Long Short Term Memory (LSTM) networks, and spiking neural networks (SNN).

An example application of the illustrative embodiments is the field of structural dynamics, where applications such as reduced order modeling of complex systems control and structural health monitoring (SHM) of complex systems require real-time detection of anomalous system behavior. Examples include mechanical systems in which the system stiffness shifts dramatically and jointed structural systems. Frictional joints are well-studied, but current reduced order models cannot practically capture the full extent of the underlying nonlinear physics. To mitigate error accumulation, autoregressive models (a form of neural networks) and k-step ahead prediction are typically used. The corrective mechanism of the illustrative embodiments advance modeling capabilities.

SHM is defined as a four-level hierarchy aiming to detect, localize, quantify, and finally predict damage on the basis of data extracted from operating engineered systems. Generative modeling approaches attempt to reproduce joint probabilistic distributions from monitoring data in order to recognize distinct condition regimes. For achieving the higher steps in the SHM hierarchy, physics-informed learning incorporates domain knowledge into the learning process. The illustrative embodiments treat this problem as adaptation to shifted domains.

When a neural network is trained to mimic time series data, it learns a mapping from patterns observed in previous time steps to the next data point in the time series. When time series deviates from the expected patterns, the neural network could fail to make accurate predictions. The method of the illustrative embodiments extends the applicability of trained neural networks to mitigate domain shift by 1) recognizing that the input domain has shifted and 2) using uncertainty quantification to drive the predictions toward a corrective path.

To quantify the model's uncertainty, the illustrative embodiments employ a dropout technique both during training and prediction. When predicting on examples from a domain that is shifted from the training, prediction is run multiple times with active dropout layers to generate an uncertainty distribution.

The method of the illustrative embodiments assumes that a neural network with dropout layers used to quantify the uncertainty in its predictions is trained to approximate a real-valued function ƒ(x, t). Input to the model is a sequence of values of ƒ over a series of previous time steps along with the value of x at time t. Output is the value of ƒ over a sequence of subsequent time steps. When the model's uncertainty exceeds a threshold value, instead of returning the model's nominal prediction for ƒ at time t, the present method updates the prediction to incorporate information from the calculated uncertainty to improve accuracy.

The illustrative embodiments infer several predictions for ƒ at time t with different subsets of neuron outputs dropped from the calculation, resulting in a distribution of predicted output values at each time step. Rather than leaving the uncertainty estimation as a simple indication of the model's confidence at time t, the method of the illustrative embodiments actively uses statistical properties of the distribution of the predicted results to serve as a corrective factor for the prediction of ƒ at time t.

The illustrative embodiments may employ different applications of the corrective factor. In one embodiment, the nominal prediction is replaced with the mean of the prediction distribution. In another embodiment, the standard deviation of the prediction distribution is added to the nominal prediction in the direction of the distribution skew.

An example application of the illustrative comprises a frictional joint structure subject to a known force. This dataset includes initial conditions, the load on the structure, and accelerometer and displacement measurements from various positions of the structure. A reduced order model of the system can be used to predict the displacement over time of structural mass elements. The ability of reduced order models of jointed structures to match experimental data is known to degrade as the structural loading on the joint increases and the nonlinear dynamics induced by the joint becomes more significant. After training the deep learning model on the system dynamics of the reduced order model of the jointed structure system, the deep learning model is then applied on experimental structure data, where the output with the corrective factor is used to predict the next time step of the displacements of the real structure. Because the reduced order model used to train the deep learning model (embodied in the neural network) is unable to capture all the physics necessary to predict the true system dynamics, the deep learning model of the illustrative embodiments will identify that the real inputs have shifted from the training domain inputs and compensate for the missing physics.

Each dataset comprises multiple time steps per example (e.g., 100,000), and the prediction simulations might use different initial conditions (e.g., on the order of 100).

One of the primary challenges of employing neural networks for predictions in the time domain is the accumulation of error that arises from recursion. To mitigate this challenge, the illustrative embodiments enforce physical constraints through the loss function. Terms that require conservation of energy and momentum encourage the network to learn not only the target output, but its derivatives and the relationship between them. A byproduct of this constraint is that the problem is bounded to produce high-quality predictions in the physical domain in which it was trained. When presented with data from outside its domain, the prediction uncertainty will increase as the physical constraints are harder to enforce.

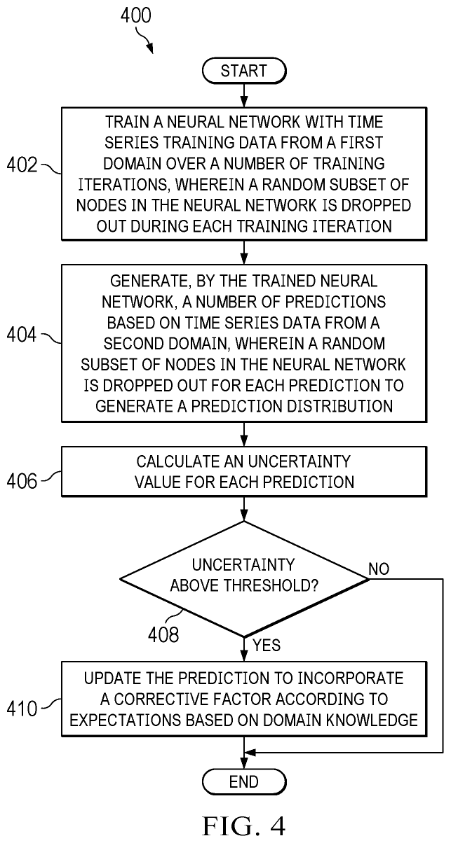

FIG. 4 depicts a flowchart illustrating a process of neural network prediction correction in accordance with an illustrative embodiment. Process 400 might be implemented with sequential prediction system 100 in FIG. 1.

Process 400 begins by training a neural network with time series training data from a first domain over a number of training iterations (step 402). During training a random subset of nodes in the neural network is dropped out during each training iteration. Node dropout might be applied to all layers of the neural network. Alternatively, node dropout might be applied only to a decoder portion of the neural network.

Process 400 is agnostic to neural network architecture type. The neural network might comprise a recurrent neural network, a transformer, a Long Short Term Memory (LSTM) network, a convolutional neural network, a multilayer perceptron, a spiking neural network, a deep belief network, etc.

The trained neural network then generates a number of predictions based on time series data from a second domain (step 404). During these predictions a random subset of nodes in the neural network is dropped out for each prediction to generate a prediction distribution. The time series data from the second domain can include a discontinuity in sequential data that does not exist in the time series data from the first domain. As with training, node dropout during the predictions might be applied to all layers of the neural network or only to a decoder portion of the neural network depending on the specific neural network architecture used.

An uncertainty value is calculated for each prediction (step 406), and process 400 determines whether the uncertainty is above a specified threshold (step 408). If the uncertainty does not exceed the threshold, process 400 ends.

Responsive to determination that the uncertainty value for a prediction does exceed the specified threshold, process 400 updates the prediction to incorporate a corrective factor according to expectations based on domain knowledge (step 410). Updating the prediction might comprise replacing the prediction with the mean of the prediction distribution. Alternatively, updating the prediction might comprise adding the standard deviation of the prediction distribution in the direction of distribution skew

Process 400 then ends.

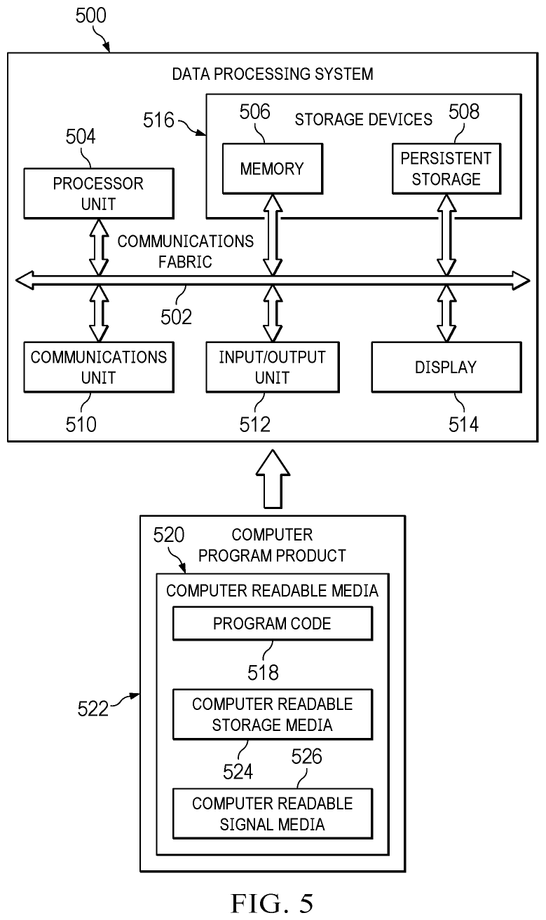

Turning to FIG. 5, a diagram of a data processing system is depicted in accordance with an illustrative embodiment. Data processing system 500 is an example of a system in which computer-readable program code or program instructions implementing processes of illustrative embodiments may be run. Data processing system 500 may be used to implement sequential prediction system 100 in FIG. 1. Turning now to FIG. 5, an illustration of a block diagram of a data processing system is depicted in accordance with an illustrative embodiment. Data processing system 500 may be used to implement computer system 150 in FIG. 1. In this illustrative example, data processing system 500 includes communications fabric 502, which provides communications between processor unit 504, memory 506, persistent storage 508, communications unit 510, input/output unit 512, and display 514. In this example, communications fabric 502 may take the form of a bus system.

Processor unit 504 serves to execute instructions for software that may be loaded into memory 506. Processor unit 504 may be a number of processors, a multi-processor core, or some other type of processor, depending on the particular implementation. In an embodiment, processor unit 504 comprises one or more conventional general-purpose central processing units (CPUs). In an alternate embodiment, processor unit 504 comprises one or more graphical processing units (GPUs).

Memory 506 and persistent storage 508 are examples of storage devices 516. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 516 may also be referred to as computer-readable storage devices in these illustrative examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508. Communications unit 510, in these illustrative examples, provides for communications with other data processing systems or devices. In these illustrative examples, communications unit 510 is a network interface card.

Input/output unit 512 allows for input and output of data with other devices that may be connected to data processing system 500. For example, input/output unit 512 may provide a connection for user input through at least one of a keyboard, a mouse, or some other suitable input device. Further, input/output unit 512 may send output to a printer. Display 514 provides a mechanism to display information to a user.

Instructions for at least one of the operating system, applications, or programs may be located in storage devices 516, which are in communication with processor unit 504 through communications fabric 502. The processes of the different embodiments may be performed by processor unit 504 using computer-implemented instructions, which may be located in a memory, such as memory 506.

These instructions are referred to as program code, computer-usable program code, or computer-readable program code that may be read and executed by a processor in processor unit 504. The program code in the different embodiments may be embodied on different physical or computer-readable storage media, such as memory 506 or persistent storage 508.

Program code 518 is located in a functional form on computer-readable media 520 that is selectively removable and may be loaded onto or transferred to data processing system 500 for execution by processor unit 504. Program code 518 and computer-readable media 520 form computer program product 522 in these illustrative examples. In one example, computer-readable media 520 may be computer-readable storage media 524 or computer-readable signal media 526.

In these illustrative examples, computer-readable storage media 524 is a physical or tangible storage device used to store program code 518 rather than a medium that propagates or transmits program code 518. Computer readable storage media 524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 518 may be transferred to data processing system 500 using computer-readable signal media 526. Computer-readable signal media 526 may be, for example, a propagated data signal containing program code 518. For example, computer-readable signal media 526 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 500 are not meant to provide architectural limitations to the manner in which different embodiments may be implemented. The different illustrative embodiments may be implemented in a data processing system including components in addition to or in place of those illustrated for data processing system 500. Other components shown in FIG. 5 can be varied from the illustrative examples shown. The different embodiments may be implemented using any hardware device or system capable of running program code 518.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for neural network prediction correction, the method comprising:
training a neural network with time series training data from a first domain over a number of training iterations, wherein a random subset of nodes in the neural network is dropped out during each training iteration;
generating, by the trained neural network, a number of predictions based on time series data from a second domain, wherein a random subset of nodes in the neural network is dropped out for each prediction to generate a prediction distribution;
calculating an uncertainty value for each prediction; and
responsive to determination that the uncertainty value for a prediction exceeds a specified threshold, updating the prediction to incorporate a corrective factor according to expectations based on domain knowledge.

2. The method of claim 1, wherein the time series data from the second domain includes a discontinuity in sequential data that does not exist in the time series data from the first domain.

3. The method of claim 1, wherein updating the prediction comprises replacing the prediction with the mean of the prediction distribution.

4. The method of claim 1, wherein updating the prediction comprises adding the standard deviation of the prediction distribution in the direction of distribution skew.

5. The method of claim 1, wherein node dropout is applied to all layers of the neural network.

6. The method of claim 1, wherein node dropout is applied only to a decoder portion of the neural network.

7. The method of claim 1, wherein the neural network comprises one of:
a recurrent neural network;
a transformer;
a Long Short Term Memory network;
a convolutional neural network;
a multilayer perceptron;
a spiking neural network; or
a deep belief network.

8. A system for neural network prediction correction, the system comprising:
a storage device that stores program instructions;
one or more processors operably connected to the storage device and configured to execute the program instructions to cause the system to:
train a neural network with time series training data from a first domain over a number of training iterations, wherein a random subset of nodes in the neural network is dropped out during each training iteration;
generate, by the trained neural network, a number of predictions based on time series data from a second domain, wherein a random subset of nodes in the neural network is dropped out for each prediction to generate a prediction distribution;
calculate an uncertainty value for each prediction; and
responsive to determination that the uncertainty value for a prediction exceeds a specified threshold, update the prediction to incorporate a corrective factor according to expectations based on domain knowledge.

9. The system of claim 8, wherein the time series data from the second domain includes a discontinuity in sequential data that does not exist in the time series data from the first domain.

10. The system of claim 8, wherein updating the prediction comprises replacing the prediction with the mean of the prediction distribution.

11. The system of claim 8, wherein updating the prediction comprises adding the standard deviation of the prediction distribution in the direction of distribution skew.

12. The system of claim 8, wherein node dropout is applied to all layers of the neural network.

13. The system of claim 8, wherein node dropout is applied only to a decoder portion of the neural network.

14. The system of claim 8, wherein the neural network comprises one of:
a recurrent neural network;
a transformer;
a Long Short Term Memory network;
a convolutional neural network;
a multilayer perceptron;
a spiking neural network; or
a deep belief network.

15. A computer program product for neural network prediction correction, the computer program product comprising:
a computer-readable storage medium having program instructions embodied thereon to perform the steps of:
training a neural network with time series training data from a first domain over a number of training iterations, wherein a random subset of nodes in the neural network is dropped out during each training iteration;
generating, by the trained neural network, a number of predictions based on time series data from a second domain, wherein a random subset of nodes in the neural network is dropped out for each prediction to generate a prediction distribution;
calculating an uncertainty value for each prediction; and
responsive to determination that the uncertainty value for a prediction exceeds a specified threshold, updating the prediction to incorporate a corrective factor according to expectations based on domain knowledge.

16. The computer program product of claim 15, wherein the time series data from the second domain includes a discontinuity in sequential data that does not exist in the time series data from the first domain.

17. The computer program product of claim 15, wherein updating the prediction comprises replacing the prediction with the mean of the prediction distribution.

18. The computer program product of claim 15, wherein updating the prediction comprises adding the standard deviation of the prediction distribution in the direction of distribution skew.

19. The computer program product of claim 15, wherein node dropout is applied to all layers of the neural network.

20. The computer program product of claim 15, wherein node dropout is applied only to a decoder portion of the neural network.
